(19) United States
(12) Patent Application Publication
(10) Pub. No.: US 2012/0292842 A1
(43) Pub. Date: Nov. 22, 2012

(54) JOUNCE BUMPER

(75) Inventors: DAMIEN VAN DER ZYPPE, CHAMPIGNY SUR MARNE (FR); SEBASTIEN THOMASSON, MEYRIN (FR); PETER LASZLO SZEKELY, PRINGY (FR); THIERRY DONIS, PARIS (FR)

(73) Assignee: E I DU PONT DE NEMOURS AND COMPANY, Wilmington, DE (US)

(21) Appl. No.: 13/471,703

(22) Filed: May 15, 2012

Related U.S. Application Data
(60) Provisional application No. 61/486,884, filed on May 17, 2011.

(51) Int. Cl. B60G 11/24

(52) U.S. Cl. 267/292

(57) ABSTRACT

Jounce bumper (14) comprising a shock absorber with a cylinder and a slidable piston rod (12), the jounce bumper (14) including an elastically compressible bumper portion (24), a mounting portion (18) and an axially extending central bore (15) positionable around the piston rod. The mounting portion (18) comprises a plurality of flexible locking legs (26) configured for insertion through an orifice (32) of a structural element (16) of the suspension system, the flexible locking legs comprising locking protrusions (36) with retaining shoulders (39) configured to engage an edge (33) of the orifice in a locked position. The locking legs have radially inwardly directed cam protrusions (38) configured to be engaged by the piston rod and are movable from an intermediate position after insertion through the structural element orifice to a locked position after insertion of the piston rod through the jounce bumper central bore.

### CROSS-REFERENCE TO RELATED APPLICATION

This application claims the benefit of U.S. Provisional application No. 61/486,884, filed May 17, 2011.

### FIELD OF THE INVENTION

This invention relates to a jounce bumper for a vehicle suspension system.

### BACKGROUND OF THE INVENTION

A vehicle suspension system typically comprises a coil spring, a shock absorber, and a jounce bumper assembly. The jounce bumper assemblies that are components of vehicle suspension systems typically comprise an elastic body mounted coaxially around a shock absorber rod and fixed to a structural element of the vehicle, the jounce bumper providing an elastic cushion for the end of travel of the shock absorber and coil spring under compression. In certain configurations, the upper end of the jounce bumper may be fixed to a cushion cup, also known as a saturation cup, within which the jounce bumper under compression is received. In certain configurations, the saturation cup may function to limit radial expansion of the jounce bumper as it is axially compressed.

It is known to affix or fasten a jounce bumper to a vehicle structural element by means of a separate retaining element with elastic cantilever latches that engage a retaining edge of the structural element, as described in U.S. Patent Application Publication 2010/127437. The retaining cantilever latches are maintained in a locked position, once the shock absorber piston rod is inserted through the central bore of the jounce bumper. A drawback of the latter construction is the force required to insert the retainer element through the orifice of the structural element and also the difficulty of removing the retainer element for disassembly of the component. The separate manufacture and subsequent assembly of the retaining element to the jounce bumper also increases cost and decreases the robustness and reliability of the jounce bumper assembly.

It would be advantageous to have available a jounce bumper that is economical to produce, that is robust and reliable, and that can be easily assembled to and removed from a vehicle suspension system.

### SUMMARY OF THE INVENTION

In one aspect the invention is directed to a jounce bumper for mounting in a vehicle suspension system comprising a shock absorber with a cylinder and a slidable piston rod, the jounce bumper comprising an elastically compressible bumper portion, a mounting portion and an axially extending central bore for receiving the piston rod therethrough, the mounting portion comprising a plurality of flexible locking legs configured for insertion through an orifice of a structural element of the suspension system, the flexible locking legs comprising locking protrusions with retaining shoulders configured to engage an edge of the orifice in a locked position, wherein the locking legs are configured in a natural state to be radially inwardly directed relative to a locked position and to be movable radially outwardly from said natural state after insertion through the structural element orifice to said locked position after insertion of the piston rod through the jounce bumper central bore and engagement of the locking legs by the piston rod.

### BRIEF DESCRIPTION OF THE DRAWINGS

FIG. 1 is a view in perspective of a jounce bumper, or a portion of a jounce bumper, according to an embodiment of the invention;

FIG. 2 is a cross-sectional view through a locking portion of the jounce bumper of FIG. 1;

FIGS. 3a and 3b are schematic cross-sectional views illustrating a mounting portion of a jounce bumper being assembled to a vehicle structural element, whereby FIG. 3a shows the jounce bumper inserted in an orifice of a saturation cup prior to insertion of a shock absorber piston rod and FIG. 3b shows the fully mounted position in which the piston rod is positioned through the jounce bumper central bore.

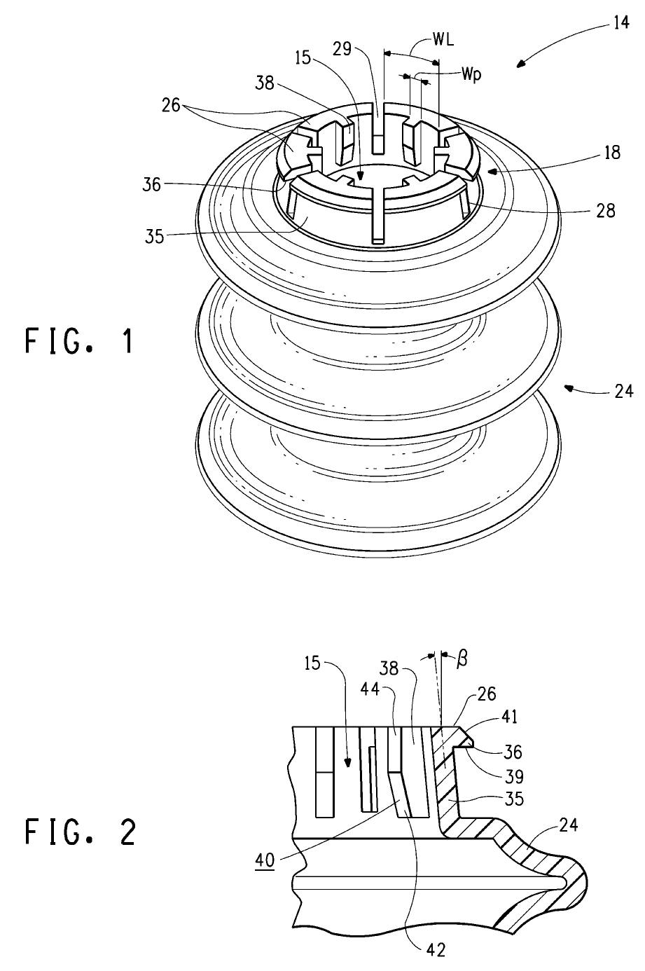

### DETAILED DESCRIPTION OF THE INVENTION

Disclosed herein is a jounce bumper for mounting on a shock absorber of a vehicle suspension system. A vehicle suspension system typically comprises a coil spring, a shock absorber, and a jounce bumper. The coil spring and shock absorber will typically be mounted between first and second vehicle structural elements that are relatively displaceable, the shock absorber comprising a cylinder and a movable piston rod. The jounce bumper comprises an elastically compressible portion and a mounting portion for securing the jounce bumper to a structural element of the vehicle suspension system, the structural element comprising for example a cushion cup. A central bore extends axially through the jounce bumper to allow insertion of the piston rod therethrough.

The jounce bumper of the invention may be made from or comprise any elastomer, including thermoset elastomers and thermoplastic elastomers, but will preferably be made from a thermoplastic elastomer. Preferably, a thermoplastic elastomer is used that has a relatively high melt viscosity (i.e. a melt flow rate between 0.5 and 8 g/10 min, more preferably between 1 and 8 g/10 min, more preferably between 2 and 6 g/10 min, particularly preferably between 3 and 5 g/10 min at 230° C. under 5 kg load according to ISO1133). Preferably the elastomer has a Shore D hardness between at or about 45 and 60D, more preferably at or about 47 to 55D (at 1s according to ISO868). Particularly preferably the elastomer is a segmented copolyetherester having soft segments of polytetramethylene ether glycol (PTMEG).

Examples of thermoset elastomers useful for the jounce bumper of the present invention include unsaturated rubbers that can be cured by sulfur vulcanization. Such elastomers include natural and synthetic polyisoprene, including natural rubber and trans-1,4-polyisoprene gutta-percha; polybutadiene; polychloroprene; butyl rubber; halogenated butyl rubber; bromobutyl rubber; styrene butadiene rubber; nitrile rubber; and hydrogenated nitrile rubber. Suitable thermoset elastomers also include unsaturated rubbers that can be cured by chemical reaction with curatives other than sulphur or alternatively by irradiation with UV light or electron beams. Such elastomers include ethylene acrylic elastomers, such as Vamac® ethylene acrylic elastomer, polyacrylate rubber; ethylene propylene rubber (EPM); ethylene propylene diene rubber (EPDM); epichlorohydrin rubber, silicone rubber; fluorosilicone rubber; fluoroelastomers, for example Viton® fluoroelastomers, Technoflon® fluoroelastomers, Fluoroel® fluoroelastomers; Aflas® fluoroelastomers, and Dai-el® fluoroelastomers; perfluoroelastomers; chlorosulfonated polyethylenes; chlorinated polyethylenes; and ethylene vinyl acetate.

Such elastomers are generally fabricated into parts by mixing them, at temperatures below those at which the curing system is activated, with curatives and other additives, such as carbon black or other fillers, and optional ingredients such as accelerators, retarders, antioxidants, antiozonants, plasticizers, oils, colorants, extenders, and processing aids. The mixing process generally takes place on a rubber mill, in an external mixer such as a Banbury mixer, in a Haake mixer, or in an extruder. The appropriate curing agents and additives will depend on the particular elastomer used and will be known to those skilled in the art. The resultant compositions, known as compounds, are generally formed into shaped articles by high temperature molding processes wherein heat and pressure are applied to the mold to activate the curing (i.e. vulcanizing or crosslinking) process. After ejection from the mold, the parts may be post-cured at elevated temperatures for several hours or more in some instances. Other curing processes known to those of skill in the art may also be used. In certain embodiments, the jounce bumper may be formed from a compound that is susceptible to radiation curing. In such instances, a thermally activated curing agent may or may not be present.

Examples of thermoplastic elastomers useful for the jounce bumper of the present invention include those defined in ISO 18064:2003(E), such as thermoplastic polyolefinic elastomers (TPO), styrenic thermoplastic elastomers (TPS), thermoplastic polyether or polyester polyurethanes (TPU), thermoplastic vulcanizates (TPV), thermoplastic polyamide block copolymers (TPA), copolyester thermoplastic elastomers (TPC) such as copolyetheresters or copolyesteresters, and mixtures thereof; additional suitable materials are thermoplastic polyesters and mixtures thereof.

Thermoplastic polyolefinic elastomers (TPO's) consist of thermoplastic olefinic polymers, for example polypropylene or polyethylene, blended with a thermoset elastomer. A typical TPO is a melt blend or a reactor blend of a polyolefin plastic, generally a polypropylene polymer, with an olefin copolymer elastomer, typically an ethylene-propylene rubber (EPR) or an ethylene-propylene-diene rubber (EPDM). Common olefin copolymer elastomers include EPR, EPDM, and ethylene copolymers such as ethylene-butene, ethylene-hexane, and ethylene-octene copolymer elastomers (for example Engage® polyolefin elastomer, which is commercially available from The Dow Chemical Co.) and ethylene-butadiene rubber.

Styrenic thermoplastic elastomers (TPS's) consist of block copolymers of polystyrene and rubbery polymeric materials, for example polybutadiene, a mixture of hydrogenated polybutadiene and polybutadiene, poly(ethylene-propylene) and hydrogenated polyisoprene. Specific block copolymers of the styrene/conjugated diene/styrene type are SBS, SIS SIBS, SEBS and SEPS block copolymers. These block copolymers are known in the art and are commercially available.

Thermoplastic polyurethanes (TPU's) consist of linear segmented block copolymers composed of hard comprising a diisocyanate, a short chain glycol and soft segments comprising diisocyanate and a long chain polyol as represented by the general formula

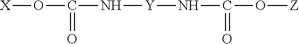

wherein

“X” represents a hard segment comprising a diisocyanate and a short-chain glycol, “Z” represents a soft segment comprising a diisocyanate and a long-chain polyol and “Y” represents the residual group of the diisocyanate compound of the urethane bond linking the X and Z segments. The long-chain polyol includes those of a polyether type such as poly(alkylene oxide)glycol or those of polyester type.

Thermoplastic vulcanizates (TPV's) consist of a continuous thermoplastic phase with a phase of vulcanized elastomer dispersed therein. Vulcanizate and the phrase “vulcanizate rubber” as used herein are intended to be generic to the cured or partially cured, crosslinked or crosslinkable rubber as well as curable precursors of crosslinked rubber and as such include elastomers, gum rubbers and so-called soft vulcanizates. TPV's combine many desirable characteristics of crosslinked rubbers with some characteristics, such as processability, of thermoplastic elastomers. There are several commercially available TPVs, for example Santoprene® and Sarlink® (TPV's based on ethylene-propylene-diene copolymer and polypropylene) which are respectively commercially available from Advanced Elastomer Systems and DSM; Nextrile™ (TPV based on nitrile rubber and polypropylene) which is commercially available from Thermoplastic Rubber Systems; Zeotherm® (TPV based on acrylate elastomer and polyamide) which is commercially available from Zeon Chemicals; and DuPont™ ETPV from E. I. du Pont de Nemours and Company, which is described in International Patent Application Publication WO 2004/029155 (thermoplastic blends comprising from 15 to 60 wt. % of polyalkylene phthalate polyester polymer or copolymer and from 40 to 85 wt. % of a crosslinkable poly(meth)acrylate or polyethylene/(meth)acrylate rubber dispersed phase, wherein the rubber has been dynamically crosslinked with a peroxide free radical initiator and an organic diene co-agent).

Thermoplastic polyamide block copolymers (TPA's) consist of linear and regular chains of polyamide segments and flexible polyether or polyester segments or soft segments with both ether and ester linkages as represented by the general formula

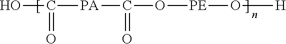

wherein

“PA” represents a linear saturated aliphatic polyamide sequence and “PE” represents for example a polyoxyalkylene sequence formed from linear or branched aliphatic polyoxyalkylene glycols or a long-chain polyol with either ether linkages or ester linkages or both linkages and mixtures thereof or copolyethers or copolyesters derived therefrom. The softness of the copolyetheramide or the copolyesteramide block copolymer generally decreases as the relative amount of polyamide units is increased.

Suitable examples of thermoplastic polyamide block copolymers for use in the present invention are commercially available from Arkema or Elf Atochem under the trademark Pebax®.

For an excellent balance of grease resistance, high temperature durability and low temperature flexibility, the jounce bumper according to the present invention may be made from thermoplastic polyester compositions. Preferred thermoplastic polyesters are typically derived from one or more dicarboxylic acids (where herein the term “dicarboxylic acid” also refers to dicarboxylic acid derivatives such as esters) and one or more diols. In preferred polyesters the dicarboxylic acids comprise one or more of terephthalic acid, isophthalic acid, and 2,6-naphthalene dicarboxylic acid, and the diol component comprises one or more of HO(CH2)nOH (I); 1,4-cyclohexanedimethanol; HO(CH2CH2O)mCH2CH2OH (II); and HO(CH2CH2CH2CH2O)zCH2CH2CH2CH2OH (III), wherein n is an integer of 2 to 10, m on average is 1 to 4, and z is on average about 7 to about 40. Note that (II) and (III) may be a mixture of compounds in which m and z, respectively, may vary and that since m and z are averages, they need not be integers. Other dicarboxylic acids that may be used to form the thermoplastic polyester include sebacic and adipic acids. Hydroxycarboxylic acids such as hydroxybenzoic acid may be used as comonomers. Specific preferred polyesters include poly(ethylene terephthalate) (PET), poly(trimethylene terephthalate) (PTT), poly(1,4-butylene terephthalate) (PBT), poly(ethylene 2,6-naphthoate), and poly(1,4-cyclohexyldimethylene terephthalate) (PCT).

Copolyester thermoplastic elastomers (TPC) such as copolyetheresters or copolyesteresters are copolymers that have a multiplicity of recurring long-chain ester units and short-chain ester units joined head-to-tail through ester linkages, said long-chain ester units being represented by formula (A):

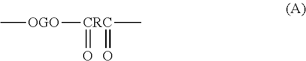

and said short-chain ester units being represented by formula (B):

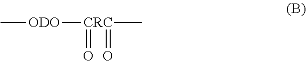

wherein

G is a divalent radical remaining after the removal of terminal hydroxyl groups from poly(alkylene oxide)glycols having preferably a number average molecular weight of between about 400 and about 6000; R is a divalent radical remaining after removal of carboxyl groups from a dicarboxylic acid having a molecular weight of less than about 300; and D is a divalent radical remaining after removal of hydroxyl groups from a diol having a molecular weight preferably less than about 250; and wherein said copolyetherester(s) preferably contain from about 15 to about 99 wt. % short-chain ester units and about 1 to about 85 wt. % long-chain ester units.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

The term “short-chain ester units” as applied to units in a polymer chain of the copolyetheresters refers to low molecular weight compounds or polymer chain units. They are made by reacting a low molecular weight diol or a mixture of diols with a dicarboxylic acid to form ester units represented by Formula (B) above. Included among the low molecular weight diols which react to form short-chain ester units suitable for use for preparing copolyetheresters are acyclic, alicyclic and aromatic dihydroxy compounds. Preferred compounds are diols with about 2-15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. Especially preferred diols are aliphatic diols containing 2-8 carbon atoms, and a more preferred diol is 1,4-butanediol.

Copolyetheresters that have been advantageously used for the manufacture of the jounce bumper of the present invention are commercially available from E. I. du Pont de Nemours and Company, Wilmington, Del. under the trademark Hytrel® copolyetherester elastomer.

According to a preferred embodiment, jounce bumpers according to the present invention are made of copolyester thermoplastic elastomers (TPC) such as copolyetheresters or copolyesteresters, and mixtures thereof. More preferably a copolyether ester is used that is made from an ester of terephthalic acid, e.g. dimethylterephthalate, 1-4 butanediol and a poly(tetramethylene ether) glycol. The weight percentage of short-chain ester units is about 50 where the remainder is long-chain ester units. The copolyetherester elastomer has a high melt viscosity with a melt flow rate of about 4 g/10 nm at 230° C. under 5 kg load as measured according to ISO1133. Its hardness is about 47 Shore D at 1s as measured according to ISO868.

The material used to manufacture the jounce bumpers according to the present invention may comprise additives including plasticizers; stabilizers; antioxidants; ultraviolet absorbers; hydrolytic stabilizers; anti-static agents; dyes or pigments; fillers, fire retardants; lubricants; reinforcing agents such as fibers, flakes or particles of glass; minerals, ceramics, carbon among others, including nano-scale particles; processing aids, for example release agents; and/or mixtures thereof. Suitable levels of these additives and methods of incorporating these additives into polymer compositions are known to those of skill in the art.

The thermoplastic jounce bumpers of the invention may be made by any shaping operation or method suitable for shaping thermoplastic elastomer material. Examples of such shaping operations or methods comprise operations that include: injection molding, extrusion (e.g. corrugated extrusion), and blow molding (including extrusion blow molding and injection blow molding). Blow molding is particularly preferred as it allows good control over the final geometry of the part and a good balance between the control of the final geometry and the cost of the process.

The mounting portion of the jounce bumper of the invention comprises a plurality of flexible locking legs configured for insertion through an orifice of said structural element of the vehicle suspension system, the flexible locking legs comprising retaining shoulders configured to engage an edge of the orifice in a locked position. The locking legs are movable from an intermediate position after insertion through the structural element orifice to a locked position after insertion of the piston rod through the jounce bumper central bore. The locking legs may advantageously comprise radially inwardly directed cam protrusions configured to be engaged by the piston rod. In certain embodiments, the locking legs may be arranged in a split tubular shape around the central bore.

Referring now to the figures, in one embodiment, the jounce bumper assembly of the present invention comprises a jounce bumper 14 and a cushion or saturation cup 16. The cushion cup 16 is part of, or affixed to or fastened to, the vehicle structural element or elements to which the end of the shock absorber piston rod 12 is fixed. The cushion cup 16 serves to receive the jounce bumper 14 therein, as it is being compressed, and to limit the radial expansion of the jounce bumper 14 during compression thereof.

The jounce bumper 14 is fixed to the cushion cup 16 or to another structural element of the vehicle suspension system at the end of the shock absorber piston rod 12. Although the cushion cup is advantageous in many configurations, certain jounce bumpers may function without the cushion cup and may thus be affixed onto a structural element that is not in the form of a cushion cup.

The cushion cup 16 or other structural element comprises an end wall portion 30 with an orifice 32 forming a passage through which the piston rod of the shock absorber 12 extends. An edge 33 of the orifice also serves for fixing of the jounce bumper, as will be described in more detail herein below. The jounce bumper 14 comprises an elastically compressible portion 24, a mounting portion 18 for affixing the jounce bumper to a structural element of the suspension system, and a central bore 15 extending through the compressible portion and the mounting portion for enabling the mounting of the jounce bumper around the shock absorber piston rod 12.

The mounting portion may advantageously be integrally formed with the jounce bumper elastically compressible portion. For example, referring to the figures, mounting portion 18 is advantageously integrally formed with the elastically compressible portion. In an advantageous embodiment, the mounting portion is formed with the compressible portion as a single molded piece of the same material, although within the scope of the invention, it is possible to have a mounting portion that is formed of, or comprising, a different material from the elastically compressible portion, for example in a multi-component molding process. The jounce bumper may advantageously be prepared by an injection blow molding process, for instance as described in U.S. Patent Application Publication 2008/0272529.

The mounting portion can also be formed as a separate component that is over-molded, bonded, or otherwise affixed to the elastically compressible portion.

The mounting portion of the jounce bumper of the invention comprises a plurality of flexible locking legs configured for insertion through an orifice of said structural element of the vehicle suspension system, the flexible locking legs comprising retaining shoulders configured to engage an edge of the orifice in a locked position. The retaining shoulders of the flexible locking legs are configured to partially engage an edge of the structural element orifice in the intermediate position prior to insertion of the piston rod in the central passage.

The locking legs are movable from an intermediate position after insertion through the structural element orifice to a locked position after insertion of the piston rod through the jounce bumper central bore. The locking legs may advantageously comprise radially inwardly directed cam protrusions configured to be engaged by the piston rod.

As illustrated in the figures, the mounting portion 18 comprises a plurality of locking legs 26 that are configured to engage the edge 33 of the orifice 32 of the cushion cup 16 or structural element, the locking legs comprising a locking protrusion 36 with a retaining shoulder 39 for engaging the edge 33 of the orifice 32 and a chamfer 41 on a leading edge of the protrusion to facilitate insertion of the locking leg through the orifice. The locking legs may be arranged in a split ring or tubular shape with gaps 29 between adjacent locking legs. Each locking leg thus has a cantilever leg extension 35 extending from an end of the elastically compressible portion of the jounce bumper to a free end from which the retaining shoulder 39 protrudes radially outwardly.

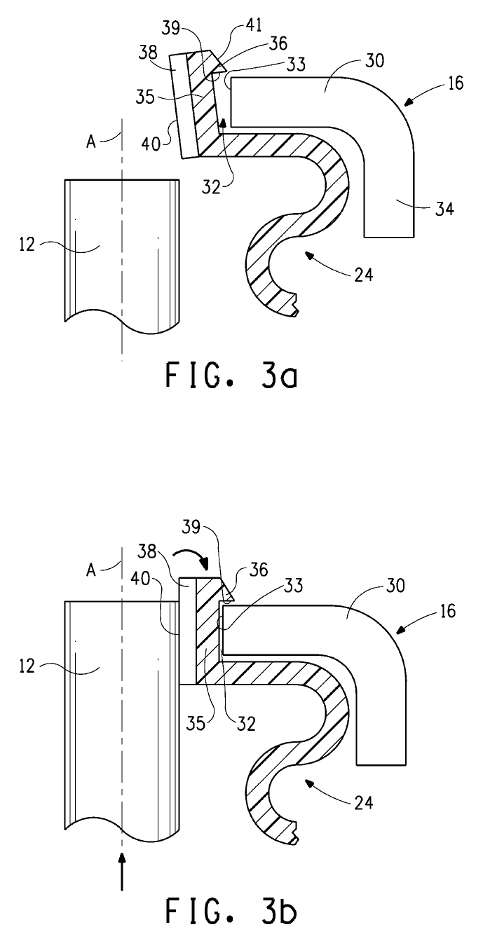

The locking legs may advantageously further comprise cam protrusions. The cam protrusions may advantageously comprise a tapered portion for initial engagement with the piston rod during insertion through the central bore, and a locking portion configured to engage the piston rod for full engagement in the locked position. In certain embodiments, the cam protrusions may be in the form of radially inwardly directed ribs extending axially along the locking legs, for instance positioned along a center of each locking leg. Referring to the figures, in one embodiment cam protrusions 38 extend radially inwardly from a radially inner surface of the locking leg extension 35. The cam protrusions 38 define a cam surface 40 having a tapered portion 42 directed towards the compressible portion of the jounce bumper, and a locking portion 44 directed towards a free end of the locking leg. The tapered portion 42 is configured to allow easy insertion and guiding of the shock absorber piston rod through the central bore during assembly and to outwardly pivot the locking legs into the fully locked position as shown in FIG. 3b. The locking portion 44 of the cam protrusion 38 is dimensioned such that, when the shock absorber rod 12 is fully inserted through the jounce bumper central bore, the locking legs are pivoted radially outwardly until the retaining shoulders 36 fully engage the edge 33 of the orifice 32 of the structural element 16, with the outer radial surface of the locking leg extensions 35 in abutment against the edge of the orifice. In a natural state, i.e. in an unassembled, unlocked configuration, as best seen in FIG. 2b or 3a, the locking leg extensions 35 may advantageously be inclined radially inwardly towards the axial axis A of the bore 15, so that the locking protrusion has only a small interference or contact with the edge 33 of the orifice during insertion of the mounting portion 18 through the orifice. The small interference allows the jounce bumper to be assembled to the structural element with a low mounting force and held in place until the shock absorber piston rod is inserted through the jounce bumper bore 15.

Within the scope of the invention, instead of inclining the locking leg extensions towards the axis A, other shapes or inwardly directed protuberances that allow the radial outward movement of the locking legs when engaged by the shock absorber piston rod may be implemented.

The locking legs may advantageously be configured to be rotated from the natural state to the locked state by an angle of between 5° and 15°. In an embodiment, the locking legs may be configured to be pivoted radially outwardly from the natural state to the fully locked state by an angle β of between 3° and 30°, preferably between 5° and 15° It may be noted that angle β is defined by the interference or degree of contact with the inner diameter of the saturation cup and the height of the locking legs. Preferably the interference is between 0.5 to 2 mm depending on the load assembly requirements. The height of the locking legs may vary over a wide range depending of shape of the saturation cup and the manufacturing process, but preferably lies in a range between 2 mm to 8 mm.

The cam protrusions 38 may advantageously be in the form of axially extending ribs having a general or average circumferential width Wp that is less than the general average circumferential width WL of the corresponding locking leg extension. A cam surface of the cam protrusion in contact with the piston rod may advantageously have a circumferential width (Wp) that is less than 50% of a width WL of the locking leg. Thus, for instance, the width Wp of the cam protrusion may advantageously be in the range of 15-35% of the width WL of the locking leg portion 35.

The above-described configuration of the cam protrusion and locking leg advantageously allows the locking leg extension to have an optimal degree of flexibility to allow easy insertion of the piston rod 12 past the cam protrusions and outward biasing of the locking legs into the locked position, yet provide a very robust and rigid locked engagement of the locking legs with the edge of the orifice of the structural element. The cam protrusions also advantageously allow the jounce bumper mounting portion to be easily configured for orifices of different diameters in relation to shock absorber piston rods of different diameters in a flexible and easy manner.

Advantageously, the force required to push the locking legs of the jounce bumper through the orifice of the saturation cup is thus very low, enabling easy assembly of the jounce bumper to the vehicle suspension system and reducing the risk of damaging the jounce bumper during assembly. Moreover, the jounce bumper may be easily removed and replaced if repair of the suspension system is required (provided the piston rod is removed before initiating such repair or replacement). A secure and robust mounting of the jounce bumper to the vehicle suspension system is nevertheless provided by the locking effect of the shock absorber rod through the central bore of the jounce bumper. Also advantageously, the cam protrusions enable the locking legs to be sufficiently flexible and optimally configured for the dimensions of the orifice of the saturation cup or other structural element on which the jounce bumper is mounted, thus allowing easy design adaptation of the jounce bumper to the dimensions of the orifice and of the shock absorber rod without compromising the flexibility and strength of the locking legs.

1. A jounce bumper (14) for mounting in a vehicle suspension system comprising a shock absorber with a cylinder and a slidable piston rod (12), the jounce bumper (14) comprising an elastically compressible bumper portion (24), a mounting portion (18) and an axially extending central bore (15) for receiving the piston rod therethrough, the mounting portion (18) comprising a plurality of flexible locking legs (26) configured for insertion through an orifice (32) of a structural element (16) of the suspension system, the flexible locking legs comprising locking protrusions (36) with retaining shoulders (39) configured to engage an edge (33) of the orifice in a locked position, wherein the locking legs are configured in a natural state to be radially inwardly directed relative to a locked position and to be movable radially outwardly from said natural state after insertion through the structural element orifice to said locked position after insertion of the piston rod through the jounce bumper central bore and engagement of the locking legs by the piston rod.

2. A jounce bumper according to claim 1, wherein the locking legs are inclined towards an axis of the jounce bumper central bore in a natural state.

3. A jounce bumper according to claim 1, wherein the locking legs are configured to be rotated from said natural state to said locked state by an angle of between 5° and 15°.

4. A jounce bumper according to claim 1, wherein the locking legs comprise radially inwardly directed cam protrusions (38) configured to engage the piston rod inserted through the jounce bumper central bore.

5. A jounce bumper according to claim 4, wherein the cam protrusions are in the form of radially inwardly directed ribs extending axially along the locking legs.

6. A jounce bumper according to claim 5, wherein the cam protrusions are positioned along a center of each locking leg.

7. A jounce bumper according to claim 4, wherein the cam protrusions comprise a tapered portion (42) for initial engagement with the piston rod during insertion of the rod through the central bore, and a locking portion (44) configured to engage the piston rod for full engagement in the locking position.

8. A jounce bumper according to claim 4, wherein a surface of the cam protrusion in contact with the piston rod has a circumferential width (Wp) that is less than 50% of a width (WL) of the locking leg.

9. A jounce bumper according to claim 8, wherein the surface of the cam protrusion in contact with the piston rod has a circumferential width (Wp) that is between 15% and 35% of the width (WL) of the locking leg.

10. A jounce bumper according to claim 1, wherein the retaining shoulders of the flexible locking legs are configured to partially engage an edge of the structural element orifice in the intermediate position prior to insertion of the piston rod in the central bore of the jounce bumper.

11. A jounce bumper according to claim 1, wherein the mounting portion (18) is integrally formed with the elastically compressible bumper portion (24).

12. A jounce bumper according to claim 11, wherein the mounting portion (18) is formed of the same material as the elastically compressible bumper portion (24).

13. A jounce bumper according to claim 11, wherein the mounting portion (18) is integrally formed with the elastically compressible bumper portion (24) in a molding process.

14. A jounce bumper according to claim 1, wherein the locking legs are arranged in a split tubular shape around the jounce bumper central bore.
